(19) United States
(12) Patent Application Publication
(10) Pub. No.: US 2018/0148383 A1
(43) Pub. Date: May 31, 2018

(54) SURFACE TREATMENT METHOD FOR CERAMIC

(71) Applicant: Metal Industries Research & Development Centre, Kaohsiung (TW)

(72) Inventors: Li-Wen Weng, Kaohsiung City (TW); Chun-Chieh Tseng, Kaohsiung City (TW); Yau-Chia Liu, Kaohsiung City (TW); Chih-Lung Lin, Kaohsiung City (TW)

(73) Assignee: Metal Industries Research & Development Centre, Kaohsiung (TW)

(21) Appl. No.: 15/636,661

(22) Filed: Jun. 29, 2017

(30) Foreign Application Priority Data
Nov. 29, 2016 (TW) 105139211

(51) Int. Cl. C04B 41/45; C04B 41/49; C04B 41/50

(52) U.S. Cl. CPC C04B 41/4537; C04B 41/4505; C04B 2237/50; C04B 41/50; C04B 2235/3244; C04B 41/4905

(57) ABSTRACT

A ceramic surface treatment method includes the following steps. An antibacterial ion and a sol-gel solution containing a silane compound are mixed to form a treatment solution. Next, a ceramic substrate is placed in the treatment solution to perform a treatment bonding reaction such that the antibacterial ion in the treatment solution can be grafted to the surface of the ceramic substrate via the silane compound. Next, a sintering condensation reaction is performed on the ceramic substrate after the treatment bonding reaction to form a protective film on the surface of the ceramic substrate. The protective film is attached to the surface of the ceramic substrate via a hydrophobic layer, and the antibacterial ion is spread on the hydrophobic layer.

### CROSS-REFERENCE TO RELATED APPLICATION

This application claims the priority benefit of Taiwan application serial no. 105139211, filed on Nov. 29, 2016. The entirety of the above-mentioned patent application is hereby incorporated by reference herein and made a part of this specification.

### BACKGROUND OF THE INVENTION

### Field of the Invention

The invention relates to a ceramic surface treatment method, and more particularly, to a ceramic surface treatment method having both oral aesthetics and stain-resistance and antibacterial properties.

### Description of Related Art

Ceramic zirconium oxide is generally used as the material for dentures and implant prostheses in the current market. In addition to having properties such as high strength, hardness, high-temperature resistance, acid-base corrosion resistance, and high chemical stability desired in precision ceramics, zirconium oxide also has higher toughness than the average ceramic and relatively good biocompatibility, and is therefore extensively applied in human medicine.

In prior art, usually only a surface polishing treatment is performed after the molding of a ceramic prosthesis to provide surface gloss, such that the ceramic is aesthetically-pleasing and smooth, and food does not readily remain on the prosthesis. That is, oral aesthetics is heavily emphasized. However, the aforementioned treatment method cannot prevent bacterial adhesion, and therefore periodontal diseases or dental caries caused by plaque attached to the denture or prosthetic surface readily occur.

Based on the above, the development of a ceramic surface treatment method that can achieve both oral aesthetics and stain-resistance and antibacterial effects to improve various diseases of inflammation around the teeth caused by climbing proportions of periodontal diseases through a surface treatment technique is an important research topic currently.

### SUMMARY OF THE INVENTION

The invention provides a ceramic surface treatment method that can form a protective coating having all of hydrophobic, stain-resistance, translucent, and antibacterial properties on a ceramic prosthesis surface.

The ceramic surface treatment method of the invention includes the following steps. An antibacterial ion and a sol-gel solution containing a silane compound are mixed to form a treatment solution. Next, a ceramic substrate is placed in the treatment solution to perform a treatment bonding reaction such that the antibacterial ion in the treatment solution can be grafted to the surface of the ceramic substrate via the silane compound. Next, a sintering condensation reaction is performed on the ceramic substrate after the treatment bonding reaction to form a protective film on the surface of the ceramic substrate. The protective film is attached to the surface of the ceramic substrate via a hydrophobic layer, and the antibacterial ion is spread on the hydrophobic layer.

In an embodiment of the invention, the silane compound includes at least two selected from the group consisting of tetraethyl orthosilicate (TEOS), 3-triethoxysilylpropylamine (APTES), (3-mercaptopropyl)trimethoxysilane (MPTMS), methyltriethoxysilane (MTES), methyltrimethoxysilane (MTMS), methyltriethoxysilane (MTEOS), and hexamethyldisilazane (HMDS).

In an embodiment of the invention, the material of the ceramic substrate includes zirconium oxide.

In an embodiment of the invention, the ceramic substrate includes a denture or an implant prosthesis.

In an embodiment of the invention, the thickness of the protective film is 10 nm to 200 nm.

In an embodiment of the invention, the antibacterial ion includes silver ion, gold ion, copper ion, titanium ion, or platinum ion.

In an embodiment of the invention, the weight percentages of the antibacterial ion and the silane compound in the treatment solution are respectively 5% to 30%, and the molar concentration ratio of the antibacterial ion and the silane compound is 1:4.

In an embodiment of the invention, the antibacterial ion and the sol-gel solution are mixed at a temperature of 40° C. to 100° C. and a rotational speed of 500 rpm to 2000 rpm.

In an embodiment of the invention, the pH value of the treatment solution is 2.0 to 4.0.

In an embodiment of the invention, the reaction time of the treatment bonding reaction is 60 minutes to 180 minutes.

In an embodiment of the invention, the sintering condensation reaction is performed at a temperature of 300° C. to 500° C. for 20 minutes to 60 minutes.

Based on the above, the invention provides a ceramic surface treatment method in which surface treatment is performed on ceramic via a chemical sol-gel technique, a silane compound provided with an antibacterial ion forms a protective film on a ceramic zirconium oxide surface, and then dense protection is formed by high-temperature condensation such that a protective coating having all of hydrophobic, stain-resistance, translucent, and antibacterial properties is formed on a ceramic prosthesis surface. As a result, the protective coating can be used as the surface stain-resistant and antibacterial glaze of dental dentures and prostheses to reduce the possibility of oral inflammation and various oral chronic diseases caused by oral plaque and the adhesion of food particles.

In order to make the aforementioned features and advantages of the invention more comprehensible, embodiments are described in detail below.

### DESCRIPTION OF THE EMBODIMENTS

The invention provides a ceramic surface treatment method including the following steps. First, an antibacterial ion and a sol-gel solution containing a silane compound are mixed to form a treatment solution. Next, a ceramic substrate is placed in the treatment solution to perform a treatment bonding reaction such that the antibacterial ion in the treatment solution can be grafted to the surface of the ceramic substrate via the silane compound. Next, a sintering condensation reaction is performed on the ceramic substrate after the treatment bonding reaction to form a protective film on the surface of the ceramic substrate. The protective film is attached to the surface of the ceramic substrate via a hydrophobic layer, and the antibacterial ion is spread on the hydrophobic layer.

Before the ceramic surface treatment method of the invention is performed, a cleaning pre-treatment process of the ceramic surface can first be performed to remove impurities or residues remaining on the ceramic surface. The cleaning pre-treatment process of the ceramic surface can include washing the ceramic surface via oscillation using ultra-pure water and acetone in order for 5 minutes and repeating the step once.

In the following, the various details in the ceramic surface treatment method of the invention is described in detail.

### <Forming of Treatment Solution>

In the ceramic surface treatment method of the invention, an antibacterial metal ion and a sol-gel solution containing a silane compound are mixed to form an acidic treatment solution having a pH value of, for instance, 2.0 to 4.0. More specifically, the weight percentages of the antibacterial ion and the silane compound in the treatment solution are respectively, for instance, 5% to 30%, and the rest is composed of water and a solvent, and the solvent can be alcohol, but is not limited thereto. The molar concentration ratio of the antibacterial ion and the silane compound is preferably 1:4. In the present embodiment, the antibacterial ion and the sol-gel solution are, for instance, mixed at a temperature of 40° C. to 100° C. for about 1.5 hours to 2 hours, and the rotational speed is, for instance, 500 rpm to 2000 rpm.

In the present embodiment, the antibacterial metal ion can include silver ion, gold ion, copper ion, titanium ion, or platinum ion. However, the invention is not limited thereto, and other metal ions having antibacterial effect can also be used. Since the cell wall of the bacteria is mostly negatively-charged, when a metal ion with a positive charge is in contact with bacteria, a pulling force can be generated when the number of positive and negative ions is not balanced. As a result, the cell wall of the bacteria is pulled apart into a hole such that a cell wall cannot be synthesized and reproduction is affected, and therefore oral bacteria cannot grow and reproduce on the denture or prosthesis surface. An antibacterial effect is thus achieved.

In the present embodiment, the silane compound can include at least two selected from the group consisting of tetraethyl orthosilicate (TEOS), 3-triethoxysilylpropylamine (APTES), (3-mercaptopropyl)trimethoxysilane (MPTMS), methyltriethoxysilane (MTES), methyltrimethoxysilane (MTMS), methyltriethoxysilane (MTEOS), and hexamethyldisilazane (HMDS). In particular, in the present embodiment, TEOS and MTES are selected to be mixed into a sol-gel solution, and the molar concentration ratio is preferably 1:1. However, the invention is not limited thereto, and other silane compounds that can form a sol-gel solution can also be used.

### <Treatment Bonding Reaction>

In the ceramic surface treatment method of the invention, after the treatment solution is formed, the ceramic substrate is placed in the treatment solution to perform a treatment bonding reaction. In the present embodiment, the material of the ceramic substrate can include zirconium oxide, and the ceramic substrate is, for instance, denture or implant prosthesis. The surface of the ceramic substrate usually produces oxide, such that oxygen on the ceramic substrate and silicon in the silane compound in the treatment solution form an ion valence junction, and the antibacterial ion is grafted to the ceramic substrate surface via the silane compound at the same time. More specifically, the reaction time of the treatment bonding reaction is, for instance, 60 minutes to 180 minutes.

### <Sintering Condensation Reaction>

In the ceramic surface treatment method of the invention, after the treatment bonding reaction is performed, a sintering condensation reaction is performed on the ceramic substrate to form a protective film having a thickness of, for instance, 10 nm to 200 nm on the surface of the ceramic substrate, wherein the protective film is attached to the surface of the ceramic substrate via a hydrophobic layer, an antibacterial ion is spread on the hydrophobic layer, and the protective film can be stored after the temperature is reduced to room temperature. In the present embodiment, the sintering condensation reaction is, for instance, performed at a temperature of 300° C. to 500° C. for 20 minutes to 60 minutes.

The invention provides a ceramic surface treatment method that performs ceramic surface treatment with a silane compound and an antibacterial metal ion via a chemical sol-gel technique, wherein sol-gel assists the bonding of the ceramic substrate surface and the antibacterial ion, and a dense protective layer is formed by a high-temperature condensation reaction. The silane compound in the treatment solution can form a hydrophobic stain-resistant protective layer having a surface contact angle of 90° or more on the ceramic surface to reduce sticking of food particles and the forming of oral plaque. At the same time, the metal ion in the treatment solution has an antibacterial effect to provide surface antibacterial properties to the dental ceramic denture or prosthesis, and therefore risks such as oral diseases, inflammation, and infection caused by poor oral hygiene can be reduced to achieve the aesthetics of the oral implant prosthesis without affecting the appearance and the translucency of the prosthesis, which ensures the quality of ceramic dentures or the manufacturing process of prosthesis surface-modified glaze coating.

In the following, the ceramic surface treatment method mentioned in the embodiments is described in detail through experimental examples. However, the following experimental examples are not intended to limit the invention.

### Experimental Example

To prove that the ceramic surface treatment method of the invention can form a hydrophobic stain-resistant protective layer on a ceramic surface, the following experimental examples are provided.

It should be mentioned that, since the ceramic surface treatment method is described in detail above, details of the treatments of a ceramic surface are omitted in the following for convenience.

### Evaluation of Hydrophobic Properties of Ceramic Substrate

The surface contact angles of Example 1 with surface treatment by the treatment method of the invention and the comparative example without surface treatment were measured to evaluate the hydrophobic properties, and the measurement results are listed in Table 1. The measuring method of surface contact angle is a known technique in the art and is therefore not repeated herein.

The ceramic surface treatment method of Example 1 is as follows: silver (Ag) ion and a sol-gel solution containing TEOS and MTES were mixed in a mixing ratio of 1:4 at a temperature of 70° C. and a rotational speed of 300 rpm to form a treatment solution having a pH value of 3. Next, a ceramic substrate was placed in the treatment solution to perform a treatment bonding reaction, and the reaction time of the treatment bonding reaction was 120 minutes. Next, a sintering condensation reaction was performed on the ceramic substrate at a temperature of 400° C. for 120 minutes to form a 100 nm protective film on the surface of the ceramic substrate.

TABLE 1

| | | Comparative |
|---|---|---|
| | Example 1 | example |
| Surface contact angle | 120° | 60° |

As shown in Table 1, the surface contact angle of Example 1 with surface treatment by the treatment method of the invention is 120° and the surface contact angle of the comparative example without surface treatment is 60°. When the surface contact angle is 90° or more, good hydrophobic properties are achieved, and therefore the comparative example without surface treatment shows hydrophilic properties. In comparison, Example 1 with the surface treatment by the treatment method of the invention can form a protective coating having good hydrophobic properties and a coating thickness of 100 nm on the surface. As a result, a surface pattern with reduced sticking of food residue and plaque can be achieved without affecting the original ceramic exterior appearance.

Based on the above, the invention provides a ceramic surface treatment method in which surface treatment is performed on ceramic via a chemical sol-gel technique, a silane compound provided with an antibacterial ion forms a protective film on a ceramic zirconium oxide surface, and dense protection is formed by high-temperature condensation such that a protective coating having all of hydrophobic, stain-resistance, translucent, and antibacterial properties is formed on a ceramic prosthesis surface. As a result, oral aesthetics and stain-resistance and antibacterial effects are all achieved. Therefore, not only can dental prosthesis techniques achieve oral aesthetics and tooth glossiness, cleaning of the oral implant prosthesis surface of the patient can also be facilitated, and stain-resistance and antibacterial effects are achieved at the same time, such that the national incidence of oral disease is effectively reduced and issues derived from oral inflammation or postoperative complications are alleviated.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A ceramic surface treatment method, comprising:
mixing an antibacterial ion and a sol-gel solution containing a silane compound to form a treatment solution;
placing a ceramic substrate in the treatment solution to perform a treatment bonding reaction such that the antibacterial ion in the treatment solution is grafted to a surface of the ceramic substrate via the silane compound; and
performing a sintering condensation reaction on the ceramic substrate after the treatment bonding reaction to form a protective film on the surface of the ceramic substrate, wherein the protective film is attached to the surface of the ceramic substrate via a hydrophobic layer, and the antibacterial ion is spread on the hydrophobic layer.

2. The ceramic surface treatment method of claim 1, wherein the silane compound comprises at least two selected from the group consisting of tetraethyl orthosilicate (TEOS), 3-triethoxysilylpropylamine (APTES), (3-mercaptopropyl)trimethoxysilane (MPTMS), methyltriethoxysilane (MTES), methyltrimethoxysilane (MTMS), methyltriethoxysilane (MTEOS), and hexamethyldisilazane (HMDS).

3. The ceramic surface treatment method of claim 1, wherein a material of the ceramic substrate comprises zirconium oxide.

4. The ceramic surface treatment method of claim 1, wherein a thickness of the protective film is 10 nm to 200 nm.

5. The ceramic surface treatment method of claim 1, wherein the antibacterial ion comprises silver ion, gold ion, copper ion, titanium ion, or platinum ion.

6. The ceramic surface treatment method of claim 1, wherein a weight percentage of the antibacterial ion and a weight percentage of the silane compound in the treatment solution are respectively 5% to 30%, and a molar concentration ratio of the antibacterial ion and the silane compound is 1:4.

7. The ceramic surface treatment method of claim 1, wherein the antibacterial ion and the sol-gel solution are mixed at a temperature of 40° C. to 100° C. and a rotational speed of 500 rpm to 2000 rpm.

8. The ceramic surface treatment method of claim 1, wherein a pH value of the treatment solution is 2.0 to 4.0.

9. The ceramic surface treatment method of claim 1, wherein a reaction time of the treatment bonding reaction is 60 minutes to 180 minutes.

10. The ceramic surface treatment method of claim 1, wherein the sintering condensation reaction is performed at a temperature of 300° C. to 500° C. for 20 minutes to 60 minutes.
